(19) United States
(12) Patent Application Publication
(10) Pub. No.: US 2023/0152061 A1
(43) Pub. Date: May 18, 2023

(54) FIBER COMPOSITES HAVING STRENGTH AND FLEXIBILITY, SYSTEMS, AND METHODS THEREOF

(71) Applicant: University of Washington, Seattle, WA (US)

(72) Inventors: Sean Ghods, Seattle, WA (US); Dwayne Arola, Seattle, WA (US); Matthew Suarez, Seattle, WA (US)

(21) Appl. No.: 17/797,694

(22) PCT Filed: Feb. 1, 2021
(86) PCT No.: PCT/US21/16043

§ 371 Date: Aug. 4, 2022

Related U.S. Application Data
(60) Provisional application No. 62/970,825, filed on Feb. 6, 2020.

(51) Int. Cl. F41H 5/04; B29C 70/20; B32B 5/26; B32B 5/12; B32B 3/14; B32B 3/30; B29C 70/00; B29C 70/34; B32B 9/00; B32B 5/02; B32B 7/12; B29C 70/38; B32B 9/04; C08J 5/24

(52) U.S. Cl. CPC F41H 5/0471; B29C 70/202; B32B 5/26; B32B 5/12; B32B 3/14; B32B 3/30; B29C 70/003; B29C 70/34; B32B 9/005; B32B 5/024; B32B 7/12; B29C 70/382; B32B 9/047; B32B 5/263; F41H 5/0435; F41H 5/0464; C08J 5/247; B29L 2031/768

(57) ABSTRACT

Systems and techniques to provide a flexible, lightweight material that is also effective at protecting a body from ballistic threats are described. An example composite material described herein is fiber-based, and it includes one or more first regions where the fiber composite material is consolidated, and one or more second regions where the fiber composite material is unconsolidated. Example methods of manufacturing the composite material disclosed herein include using a specialized tool with a heated platen press or an autoclave. The tool may include one or more protrusions and/or cavities that contact a precursor composite material to transform the precursor material into a partially consolidated fiber composite material, which is suitable for use as body armor, among other potential applications for the manufactured composite material.

### CROSS-REFERENCE TO RELATED APPLICATION

This application claims the benefit of U.S. Provisional Application No. 62/970,825, titled “PARTIALLY CONSOLIDATED FIBER COMPOSITES” and filed on Feb. 6, 2020, which is incorporated by reference herein in its entirety.

### BACKGROUND

A wide range of materials have been developed for protecting a human body from physical threats. The type of material used depends on the particular application. For example, protection from bullets is much different than protection from bodily contact in sports. Therefore, the material design solution may vary depending on the desired level of protection. Fibers and fiber-reinforced composites are used for ballistics protection. Kevlar® is a synthetic fiber that was developed by DuPont® and has been used extensively for flexible ballistics protection. Depending on the level of ballistic threat, a number of layers of woven Kevlar® can be stacked, sewn together, and wrapped in a cloth sheet. With nonwoven composite fabrics, such as aramid and ultra-high-molecular-weight polyethylene (UHMWPE), the unidirectional (UD) fiber bed can be impregnated with a low-volume fraction of flexible matrix. Nonwoven composite fabrics are effective for protecting against low power handgun ammunition, and they offer flexibility for improved comfort of the wearer.

If greater protection is needed, such as military-grade protection from armor piercing rifle ammunition, armor plates are often used. These armor plates are extremely rigid, and when they are worn, such as within a vest, it is difficult for the wearer to move in a natural way. Accordingly, a wearer of hard plate body armor can fatigue quickly due to forced unnatural movement, as well as the sheer weight of the plate material (e.g., steel). Currently, no material exists that is both flexible and meets the highest level (Level IV) of ballistics performance, as defined by the ballistic resistance standard of the National Institute of Justice (NIJ), an agency of the United States Department of Justice. The disclosure made herein is presented with respect to these and other considerations.

### TECHNICAL FIELD

This disclosure relates to the technical field of composite materials and processes of manufacturing composite materials.

### SUMMARY

The present disclosure relates to techniques and systems to provide a flexible, lightweight material that is also effective at protecting a body from ballistic threats, such as by meeting or exceeding the highest level (Level IV) of ballistics performance, as defined by the ballistic resistance standard of the NIJ. Various implementations described herein relate to composites, such as partially consolidated fiber composites, as well as methods of, and tooling for, production of such composites.

An example composite material described herein is fiber-based, and it includes one or more first regions where the fiber composite material is consolidated, and one or more second regions where the fiber composite material is unconsolidated. As used herein, a fiber composite material is “consolidated” when the composite material has become physically stronger and/or more solid than the same fiber composite material in its unconsolidated form. In some examples, this consolidation is achieved by applying heat and pressure to an unconsolidated fiber composite material (e.g., layers of loose fiber embedded in an uncured matrix). The applied heat and pressure causes at least the matrix to bond together and form a contiguous matrix with increased strength and rigidity. Therefore, the composite material disclosed herein is often referred to as a “partially consolidated (fiber) composite” due to some, but not all, of the fiber composite material remaining unconsolidated. The region(s) of unconsolidated fiber composite material provide the composite material with flexibility. Meanwhile, the region(s) of consolidated fiber composite material provide resistance against particular ballistic threats, such as armor-piercing rifle ammunition. Also disclosed herein is body armor, at least a portion of which can be made of the disclosed fiber composite material. In various examples, the body armor is both flexible and effective at providing military-grade protection from ballistic threats, thereby offering safety and improved mobility for the wearer.

The present disclosure also describes methods of manufacturing the composite material disclosed herein, as well as the tooling used to carry out such manufacturing methods. An example method of manufacturing a fiber composite material utilizes a specialized tool with a heated platen press. The tool may include one or more protrusions and/or cavities. The protrusions may extend from the tool, and the cavities may be defined in the tool. By virtue of the one or more protrusions and/or cavities, the tool is configured to contact some, but not all, of a precursor fiber composite material that is placed in the heated platen press. In some examples, a method of manufacturing a fiber composite material using a heated platen press includes stacking layers of precursor fiber composite material to create stacked layers of the precursor material, pressing the stacked layers in the heated platen press with the specialized tool and using a predetermined cure cycle to create a fiber composite material that is partially consolidated, and removing the partially consolidated fiber composite material from the heated platen press. When the tool is heated and pressed against a portion of the precursor material, focused (or localized) consolidation of the fiber composite material occurs within regions of the precursor material that are in contact with the tool during the pressing operation. The resulting composite material contains one or more first regions of consolidated material (i.e., the region(s) that were in contact with the tool during the pressing), and the remainder of the material remains unconsolidated because the unconsolidated material did not contact the tool during the pressing. A tool having a patterned array of features (e.g., protrusions and/or cavities) having a geometric shape and desired spacing can be used to create a manufactured fiber composite that is both flexible and substantially resistant to ballistics.

The present disclosure also describes additional methods of manufacturing the above-described partially consolidated fiber composite, as well as other types of flexible composites that are both flexible and strong, and methods of, and tooling for, manufacturing the same. In general, the composites described herein may be nonuniform across the plane of the material such that a portion(s) of the material provide military-grade (e.g., Level IV) ballistics resistance, while other portion(s) of the material provides flexibility without sacrificing protection of the wearer. In one example, a composite material may include one or more first regions of fibers embedded in a matrix, and one or more second regions of the fibers devoid of the matrix. In other examples, a composite material may include one or more first regions of fibers embedded in a first matrix, and one or more second regions of the fibers embedded in a second matrix different than the first matrix (i.e., a mixed matrix design). In such a mixed matrix design, there can be a region of overlap where the two matrix materials have a gradual border with mixed volume fractions of each matrix material. In some examples, a composite material may include one or more first regions of fibers embedded in a matrix and one or more second regions of the fibers embedded in the matrix, wherein the fibers account for a first percentage of the fiber composite material within the one or more first regions, and the fibers account for a second percentage of the fiber composite material within the one or more second regions, the second percentage different than the first percentage. In some examples, a composite may include one or more first regions of one or more first fibers, and one or more second regions of one or more second fibers that are different than the first fiber(s). Any of these composite material configurations can be used in body armor applications and may be incorporated into body armor as such, thereby providing a lightweight, flexible material that also meets the highest level of ballistics performance.

### BRIEF DESCRIPTION OF THE DRAWINGS

FIG. 1A illustrates a perspective view of an example tool for manufacturing partially consolidated fiber composites, the tool having a design that includes an array of quadrilateral-shaped protrusions.

FIG. 1B illustrates a perspective view of an example tool for manufacturing partially consolidated fiber composites, the tool having a design that includes an array of triangular-shaped protrusions.

FIG. 2 illustrates a perspective view of an example partially consolidated composite produced using the tool depicted in FIG. 1A. Alternatively, FIG. 2 may illustrate yet another example tool for manufacturing partially consolidated fiber composites, the tool having a design that includes an array of quadrilateral-shaped cavities (which is the inverse of the tool design depicted in FIG. 1A).

FIG. 3 illustrates a cross-sectional view of the partially consolidated composite depicted in FIG. 2.

FIG. 4 illustrates a perspective view of an example body armor plate. At least a portion of the body armor plate is made of a partially consolidated fiber composite.

FIG. 5 illustrates a perspective view of example modular tool pieces for use in manufacturing partially consolidated composites.

FIG. 6 illustrates a cross-sectional view of a nonuniform fiber composite, such as a mixed matrix composite.

FIG. 7 illustrates a perspective view of a tri-layer composite plate usable as body armor.

FIG. 8 illustrates a cross-sectional view of the tri-layer composite plate of FIG. 8 contained within an encapsulating material.

FIG. 9 illustrates an example process for manufacturing a fiber composite material using a heated platen press with specialized tooling.

FIG. 10 illustrates an example process for manufacturing a fiber composite material using an autoclave.

FIG. 11 illustrates an example process for manufacturing a fiber composite material by infusing matrix into a dry fiber bed.

FIG. 12 illustrates an example process for manufacturing a fiber composite material using an additive manufacturing technique.

### DETAILED DESCRIPTION

The present disclosure describes, among other things, nonuniform fiber composite materials (e.g., fiber composites having partial consolidation). Also described herein are methods of, and tooling for, manufacturing such composites to provide a composite material that is flexible and strong, thereby providing improved mobility for the wearer without sacrifice of ballistic protection. Although the examples described herein are predominantly directed to the application of ballistic protection (e.g., body armor), the fiber composite material may be utilized for any suitable application in a variety of industries, such as aerospace, extreme sportswear, or potentially other applications. In particular, the flexibility offered by the disclosed fiber composites makes them suitable for garments or other items that can be worn on a body, whether the body is that of a human, an animal, a vehicle, a robot, or any other body.

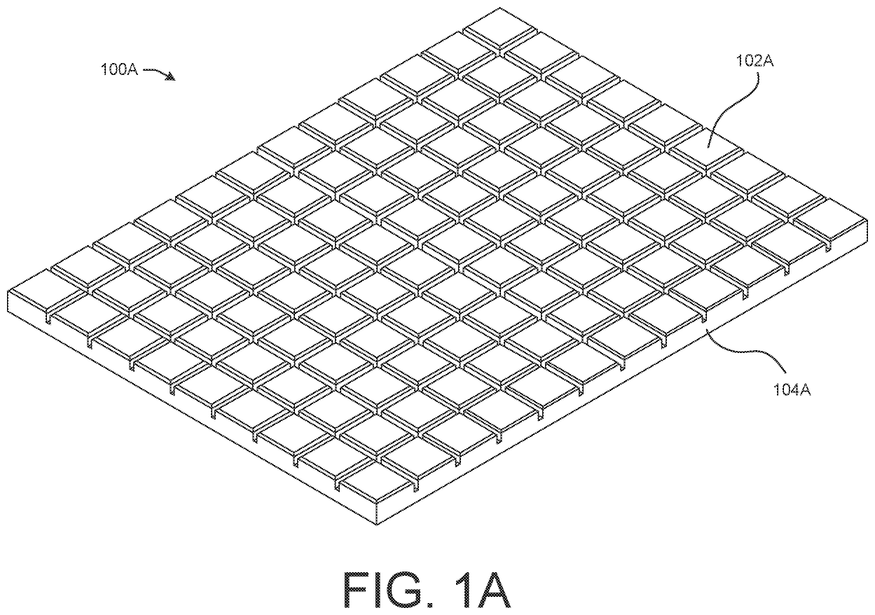

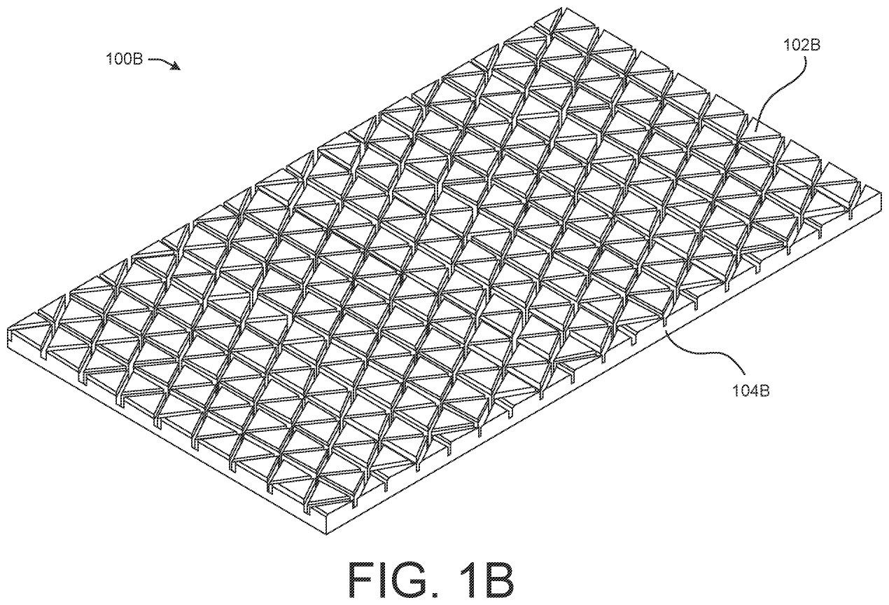

FIG. 1A illustrates a perspective view of an example tool 100A for manufacturing partially consolidated fiber composites. The tool 100A has a design that includes an array of quadrilateral-shaped protrusions 102A arranged in a grid (e.g., rows and columns). FIG. 1B illustrates a perspective view of an example tool 100B for manufacturing partially consolidated fiber composites. The tool 100B has a design that includes an array of triangular-shaped protrusions 102B.

The tools 100A and/or 100B (referred to generally herein as “tool 100”) are examples of tools that may be utilized in a heated platen press. A heated platen press includes the tool 100 and a bed. A fully unconsolidated precursor composite material is disposed between the tool 100 and the bed. The precursor fiber composite material (shortened herein to “precursor material”), for example, includes fibers and a matrix. The tool 100 is heated and pressed into the fully unconsolidated precursor material, thereby transforming the precursor material into a fiber composite material that is partially consolidated. A heated platen press can have one or more flat caul plates, such as a pair of parallel platens, to transfer heat and pressure to the precursor material, and the tool 100 can be disposed on one or both platens to distribute the heat and pressure evenly across the portions of the precursor material that are in contact with the tool 100. This heat and pressure causes consolidation of at least the matrix in the precursor material. For example, the matrix can include a thermoset resin (e.g. epoxy) that polymerizes during consolidation. In some cases, the matrix includes a thermoplastic that partially melts, and includes polymer chains that intertwine and form secondary bonds, during consolidation. In some instances, the matrix includes a metal and/or ceramic, which sinters during consolidation. Metal and/or ceramic may sinter at a greater pressure and temperature than a polymer matrix. The tool 100 may be a planar press tool (e.g., press tool plate) that can be heated to any suitable temperature, depending on the type of precursor material that is to be transformed into a partially consolidated fiber composite material. The protrusions 102A and 102B (referred to generally herein as “protrusions 102”) are raised, and they protrude or extend, from the bases 104A and 104B of the tools 100A and 100B, respectively. For instance, the protrusions 102 can include convex surfaces of the tool 100 and/or the protrusions 102 may be created by defining recessed features in a surface of the tool 100 around the protrusions 102. In some implementations, the tool 100 may be made of a metal or a metal alloy including, without limitation, steel alloy, aluminum alloy, nickel alloy, a composite, or any combination thereof.

Although the example tools 100A and 100B depicted in FIGS. 1A and 1B have patterned arrays of multiple protrusions 102, it is to be appreciated that a tool 100 may include any suitable number of protrusions 102. In some examples, a tool 100 may include a single protrusion 102. In other examples, a tool 100 may include any suitable number of multiple protrusions 102, such as tens, hundreds, or thousands of protrusions 102, arranged in any uniform and/or regular, or irregular pattern.

Furthermore, although examples of quadrilateral- and triangular-shaped protrusions 102 are depicted in FIGS. 1A and 1B, respectively, these are merely exemplary geometric shapes that can be implemented in the design of the tool 100. Accordingly, it is also to be appreciated that the a tool 100 may include protrusions 102 having any suitable geometric shape or any combination of different geometric shapes including, without limitation, circles, triangles, quadrilaterals (e.g., squares, rectangles, trapezoids, parallelograms, rhombuses, rhomboids, etc.), pentagons, hexagons, heptagons, octagons, and/or any suitable polygonal shape. More specifically, each protrusion 102 may terminate in a flat pressing surface at a distal end of the protrusion 102, the flat pressing surface being parallel to the bottom surface of the tool 100 at the base 104 of the tool 100, and the flat pressing surface having a geometric shape, such as any of the geometric shapes described herein or known to a skilled artisan. The flat pressing surfaces of multiple protrusions 102 of the tool 100 may be coplanar. Alternatively, at least a portion of the tool 100 can be curved, angled, or contoured to produce the desired shape of manufactured fiber composite material. For example, a curved tool 100 (e.g., including a curved base 104 and/or protrusions 102 with curved pressing surfaces) can be used to manufacture a partially consolidated fiber composite having a curvature. The curvature may be convex or concave, depending on the application.

In addition, the size (e.g., the surface area of the distal end) of an individual protrusion 102 can vary. Hence, in a patterned array of protrusions 102, the resolution of the array can vary from relatively high resolution to relatively low resolution. A higher resolution with smaller-sized protrusions 102 can provide increased flexibility to the manufactured composite material, whereas a lower resolution with larger-sized protrusions 102 can provide more rigidity or stiffness to the manufactured composite material.

In some implementations, the protrusions 102 extending from the tool 100 can be uniformly-spaced, as depicted in FIGS. 1A and 1B. Alternatively, spaces between the protrusions 102 may vary spatially across the dominant plane of the tool 100. The particular spacing of the protrusions 102 may be selected to optimize the flexibility of the manufactured composite material, depending on the application and/or the type of precursor material. In general, the spacing and the sizes of the pattern of protrusions 102 can be altered to achieve variations in the performance and flexibility of the manufactured composite material. By increasing the spacing between the protrusions 102, the manufactured composite material can have a larger unconsolidated area, which may result in improved flexibility. By contrast, a smaller spacing between the protrusions 102 may result in a smaller unconsolidated area, and a stiffer material overall, especially when coupled with larger-sized protrusions 102.

In some implementations, the pattern of the array of protrusions 102 can be symmetric, meaning that the resulting manufactured composite material can be flexed in at least two orthogonal directions, such as X and Y directions, within the plane of the material. Additionally, or alternatively, the asymmetric patterns may constrain flexure of the material in a particular direction that is in the plane of the material. For instance, consider an example where a partially consolidated material is being manufactured for a piece of body armor that is to be worn on the arm of a wearer. A tool 100 may be designed with a row or column of relatively long rectangular protrusions 102 to produce a piece of body armor that bends around the arm circumferentially, but is constrained from flexing (e.g., does not flex) along the arm longitudinally. The same tool, or another tool 100 may be designed with a patterned array of protrusions 102 (e.g., quadrilateral-shaped protrusions) that are rotated roughly 90-degrees in orientation relative to the rectangular protrusions 102 used to produce the upper-arm piece, which allows for producing a piece of body armor that bends at the elbow like a joint when the wearer flexes his/her arm. For an armor composite material, regions of arrays of hexagonal-shaped protrusions 102 could be used to produce a material with enhanced flexibility when covering a body part that exhibits relatively greater mobility. Therefore, a full body armor product may have material with specific patterns for specific areas of the armor, such as a first subset of spaced first regions arranged in a first pattern, a second subset of the spaced first regions arranged in a second pattern, the second pattern different than the first pattern, and so on and so forth. Furthermore, patterns may depend, at least in part, on the degree of flexibility that allows for accommodating a full range of motion for the body part that is to be covered by the material. Another factor to consider in the pattern of protrusions 102 that extend from the tool 100 is the level of protection needed for the parts of the body that are to be covered with the manufactured composite material. For example, when manufacturing a fiber composite material that is to cover a vital organ (e.g., the heart and/or lungs), flexibility may be sacrificed for greater protection in that particular area by designing a tool 100 having a relatively large-sized protrusion 102, or a tool 100 with no tessellation pattern (e.g., a flat, planar portion of the tool 100) to consolidate a relatively large region of the fiber composite material, which provides greater impact resistance.

The size of the tool 100 may vary depending on the application. For body armor applications, the tool 100 may be of a size that is suitable for use with a conventional heated platen press, such as a 24 inch×24 inch (or 60 centimeters (cm) by 60 cm) tool 100.

The method of processing the precursor material may depend on the base consolidation method of the lamella in the composite. In the case of a pressed, pre-impregnated fiber composite (prepreg), the tooling may be modified. In some implementations, a plurality of pre-impregnated layers of the precursor material are stacked and then pressed in a heated platen press with the tool 100 using a predetermined cure cycle. That is, layers of unconsolidated, precursor material may be stacked in a stacking direction, one on top of the other, before pressing the stacked layers in the stacking direction by the heated platen press using the tool 100. Each layer of precursor material may include fibers embedded in a matrix, and individual layers may be stacked in a different fiber orientation (e.g., 0/90 degrees, 0/45/90 degrees, etc.). In other words, first fibers (e.g., unidirectional (UD) fibers) in a first layer may be oriented at 0 degrees (e.g., along a plane normal to the stacking direction), a second layer adjacent to the first layer may include second fibers (e.g., UD fibers) oriented at 45 degrees of rotation relative to the base (first) layer, a third layer adjacent to the second layer may include third fibers (e.g., UD fibers) oriented at 90 degrees of rotation relative to the base (first) layer, and so on and so forth. In other examples, UD fibers may be aligned in the same direction (i.e., parallel) across all of the stacked layers, the fibers in each layer may not be UD fibers, and/or the fibers may be woven fibers.

When the stacked layers of precursor material are pressed within the heated platen press, the pattern of the tool 100 plates may be reflected in the pressure and temperature profile applied to the layers of precursor material. Those regions of the precursor material that come into contact with the protrusions 102 of the tool 100 during the pressing may become consolidated. The pressure and temperature of the pressing causes the matrix to consolidate and it mechanically locks the layers together. This process produces a more protective material of equivalent weight and reduced thickness, as compared to its unconsolidated form. The consolidated material is extremely rigid and contains many bonded interfaces for high-energy absorption. To some extent, the fibers in the precursor material may also consolidate in the regions that contact the tool 100, but whether, and to what degree, the fibers consolidate may depend on the type of fiber composite material.

The predetermined cure cycle (e.g., a time, temperature, and pressure cycle) used during the pressing may also vary, depending on the type of precursor material. For example, with UHMWPE fibers, a maximum temperature may be about 136° Celsius (C) to avoid damaging, melting, or burning of the material. For carbon fiber, a higher maximum temperature may be utilized to prevent damaging, melting, or burning of the fibers, assuming the matrix material can withstand the elevated temperature. In general, a temperature range and a pressure range may be predefined based on the type of precursor material (e.g., both the fiber and the matrix) to ensure proper consolidation of a portion(s) of the precursor material without damaging, melting, or burning the material, and without cutting through the material by application of too much pressure. In some implementations, the cure cycle may specify a rate of increasing temperature and/or pressure to a desired temperature and/or pressure. In some implementations, the cure cycle may include multiple stages of increasing pressure and/or temperature.

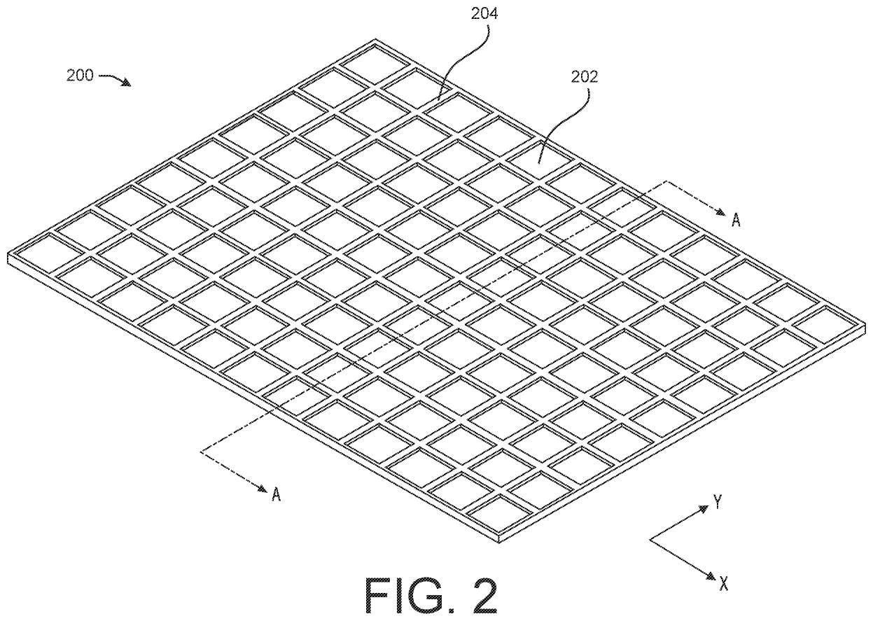

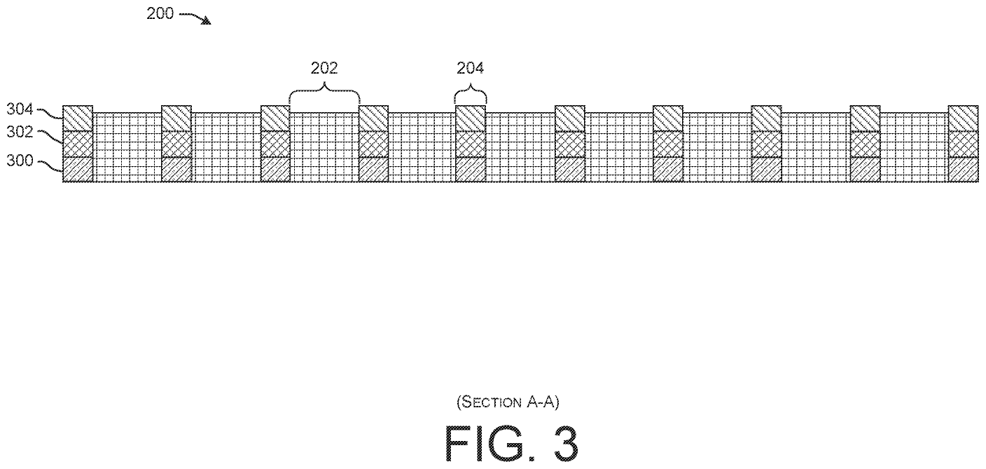

During the pressing, the areas of the material that do not contact the tool 100 (e.g., the protrusions 102) may remain unconsolidated, such that a partially consolidated fiber composite is produced. FIG. 2 illustrates a perspective view of an example partially consolidated composite 200 that may be produced using the tool 100A depicted in FIG. 1A. The composite 200 includes first regions 202 where the fiber composite material is consolidated, and second regions 204 where the fiber composite material is unconsolidated. The regions 202 and 204 may be substantially coplanar (e.g., in the same X-Y plane) when the partially consolidated composite 200 is flat and/or unflexed. The regions 202 and 204 also, or alternatively, may be positioned next to each other on a horizontal plane (i.e., not stacked vertically). FIG. 3 illustrates a cross-sectional view of the partially consolidated composite 200 depicted in FIG. 2 showing the first regions 202 and the second regions 204 from a side view. As illustrated in FIG. 2, the first regions 202 are patterned in an array (e.g., a grid, such as rows and columns of first regions 202), and each region 202 has a quadrilateral shape, which corresponds to the geometric shapes of the protrusions 102A extending from the tool 100A. Due to the consolidation of the fiber composite material in the first regions 202, the fiber composite material in those regions 202 has become stiffer (i.e., less flexible). The resulting stiffness of the regions 202 offers significant benefits in ballistic resistance; ballistic protection being one example application for the fiber composite material 200. Meanwhile, the unconsolidated regions 204 can act as hinges that are distributed throughout the plane of the material 200. The absence of consolidated matrix in these unconsolidated regions 204 enables flexure about the axis of the hinges. Depending on the tool pattern, the flexibility can be designed for magnitude and direction. An array of square-shaped consolidated regions 202, as depicted in the composite 200 of FIG. 2, results in unconsolidated lines (i.e., regions 204) in two directions (e.g., X and Y directions), the lines arranged in a grid of horizontal lines that cross vertical lines. This allows for flexibility in two orthogonal axes. If the tool 100B having the array of triangular-shaped protrusions 102B was used to manufacture a fiber composite material, the resulting composite would have flexibility in three axes because the unconsolidated regions between the triangular-shaped consolidated regions would act as hinges in three directions. Such an array of triangular-shaped consolidated regions may improve flexibility overall, as the number of directions of flexure increases, as compared to the array of square-shaped consolidated regions shown in FIG. 2. In general, adding more axes of unconsolidated composite material will further improve flexibility. In some applications, flexibility is desired over stiffness. Still, in other applications, stiffness may be desired over flexibility. The benefits of the disclosed partially consolidated fiber composite material 200 is that flexibility can be provided without sacrificing the inherent high-strength and toughness of the fiber reinforced composite that is at least partially consolidated. The resulting material has exceptionally-high energy dissipation while maintaining a reasonable degree of flexibility, thereby providing a significant advancement for personal protection.

The choice of precursor composite material that is ultimately transformed into the composite 200 may vary, depending on the application and the desired properties of the partially consolidated fiber composite 200 that is to be produced. In general, the precursor material may be any fiber-based material, such as a textile or a fabric. Dyneema® (or Spectra®) is one example precursor material that can be transformed into a partially consolidated fiber composite 200 that is suitable for high-ballistic performance. Dyneema® includes UHMWPE fibers. Other example types of precursor materials include, without limitation, polymer matrix composites, ceramic matrix composites, metal matrix composites, carbon fiber composites, nanocomposites, hybrid composites consisting of combinations of constituents and fiber size and geometry, aramid (Kevlar®, Twaron®), Vectran®, silicon carbide fiber composites, and the like. The precursor material can include any suitable fiber material including, without limitation, metal (e.g., aluminium, titanium, etc.), ceramic (Al₂O₃ (alumina), SiC, B₄C, BeO₂, Si₃N₄, ZrO₂, porcelain, or a combination thereof), polymer (polybenzoxazole (PBO; Zylon®), polybenzimidazole (PBI), aramid, polyolefins, liquid crystal polymer (LCP; Vectran®), polyester, polyether, polyamide, M5 (polyhydroquinone-diimidazopyridine (PIPD)), polyacrylonitrile, polylactide (PLA), polytetrafluoroethylene (PTFE), or a combination thereof), carbon (nanotubes, carbyne, diamond, graphite, or a combination thereof), cellulose, glass, boron, composites and/or combinations thereof. The precursor material can further include any suitable matrix material including, without limitation, metal (e.g., aluminium, titanium, etc.), ceramic (Al₂O₃ (alumina), SiC, B₄C, BeO₂, Si₃N₄, ZrO₂, AlON, porcelain, or a combination thereof), polymer (epoxies, polyimides, polyamides, polyurethanes, polyureas, polyisoprenes, polybutadienes, polychloroprenes, nitriles, silicones, fluoroelastomers, olefins, olefin elastomers, phenolics, polyketones (aliphatic and aromatic), polyesters, polyethers, PBI, polyolefins, polylactide, polycarbonate, or a combination thereof), carbon (graphite, diamond, or a combination thereof), composites and/or combinations thereof. High-modulus fibers and/or matrix materials can be used to produce an overall stiffer composite 200, while low-modulus fibers and/or matrix materials can be used to produce an overall more-flexible composite 200. Another design variable is the number of layers of precursor material, more layers producing a thicker, and, hence, stiffer composite 200, and fewer layers producing a thinner, and, hence, more-flexible composite 200 due to a reduced second moment of area. In the example fiber composite material 200 shown in the cross-sectional view of FIG. 3, the precursor material included three layers of composite material, such as a first layer 300, a second layer 302, and a third layer 304. The layers 300/302/304 are preserved in the unconsolidated regions 204, while the consolidation of the matrix material in the consolidated regions 202 cause the layers to bond and/or fuse together into a contiguous matrix material.

In some implementations, the volume fraction (or, more generally, the percentage) of fiber in certain portions of the precursor material may be chosen to provide the desired stiffness or flexibility of the manufactured composite 200. Furthermore, the fibers may be continuous or non-continuous, woven or non-woven. The fiber volume fraction, while technically serving as the reinforcement, can be any percentage of the precursor material. Since the fiber component is typically the stiffer component of the composite, laminated precursor materials having a relatively high fiber volume fraction (>40%) may be implemented. In the case of ceramic or metal matrix composites, even lower fiber volume fractions can be implemented.

In some implementations, instead of using a tool 100 with protrusions 102 that extend from the tool 100 (which creates unraised space between the protrusions 102), the reverse is also possible for use in the tooling to manufacture a partially consolidated fiber composite. Accordingly, FIG. 2 may, in some examples, represent a monolithic tool that includes one or more cavities (or recessed areas), such as a plurality of cavities shown in FIG. 2. That is, the surface of the tool 100 may include concave portions. In this alternative example, the tool includes an array of quadrilateral-shaped cavities (the cavities represented by reference numeral 202 in FIG. 2). The region(s) of the tool between the cavities are configured to contact the precursor material during the pressing that occurs in the heated platen press, resulting in a crisscross pattern of consolidated fiber composite material (e.g., bonded seams), thereby leaving square-shaped regions of unconsolidated material in the manufactured composite. This style of partially consolidated fiber composite may have reduced flexibility, as compared to the composite 200 produced using the tools 100A or 100B, but it may have greater ballistic penetration resistance. There are applications where this is preferred. For example, fiber composites used for ballistics can be “hard armor” implying that they are fully consolidated laminates and are a nearly inflexible plate of material. Using the inverse tool style having geometrically-shaped cavities, there is the benefit of making consolidated seams that are similar to the sewn seams, but significantly more rigid. The consolidated regions act as small joints that hold the composite lamella together but do not cause stress concentration at the seam. The seams increase flexibility over that of the fully consolidated hard armors with the ability to contain damage to the unconsolidated regions in the composite. Furthermore, the performance of partially consolidated composite using a tool like the one that may be represented by reference numeral 200 of FIG. 2 may be comparable to a fully consolidated panel, while reducing the pressure required. In turn, larger areas of composite could be pressed for a similar pressure or the same area with reduced energy and cost. Both damage tolerance and damage containment are concerns for armors that are expected to encounter multiple threats. For this inverse tooling that may be represented by reference numeral 200 of FIG. 2, there is a greater need for lower curvature of the raised portion's surface. Otherwise the tool may shear through the composite similar to cutting the precursor material with a high-pressure die cutter, or may cause damage to the fibers at the seam that would make this region weaker. The curvature is optional, but can be applied to the tooling to avoid any damage from processing.

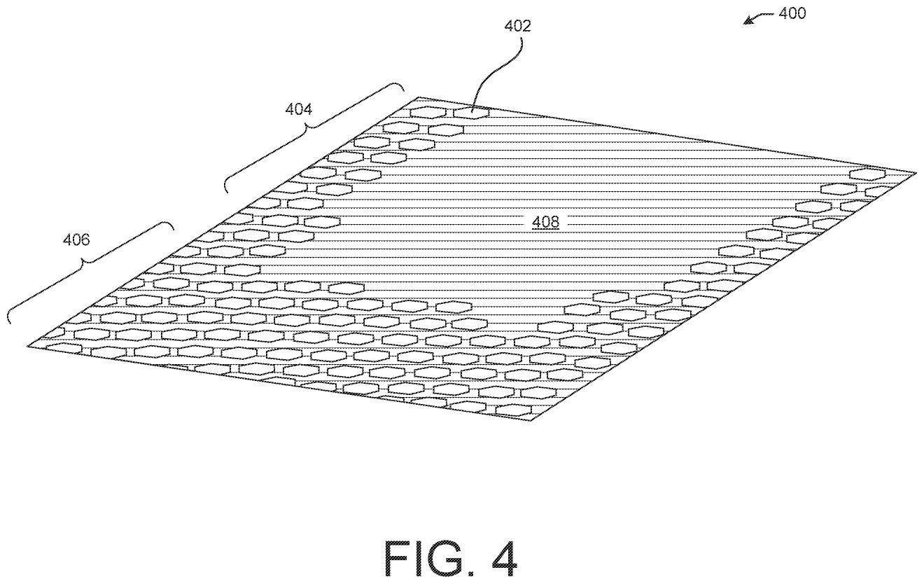

FIG. 4 illustrates a perspective view of an example body armor plate 400. At least a portion of the body armor plate 400 is made of a partially consolidated fiber composite material, such as the composite 200. By way of brief background, a standard “hard armor” plate is sold commercially in a range of sizes with the most common being 10 inch by 12 inch (or 25 cm by 30 cm). These plates are housed in a plate carrier that covers the chest and part of the abdomen of the wearer. Existing hard armor plates are inflexible, and therefore uncomfortable for the wearer. FIG. 4 depicts a body armor plate 400 having spaced hexagonal regions 402 of partially consolidated fiber composite material on a portion of the body armor plate 400, such as on the portion 404 of the plate 400 near the shoulders and/or on the portion 406 of the plate 400 that is to cover the abdominal muscles when the plate 400 is housed in the plate carrier worn by a wearer. This partial consolidation—with regions 402 of unconsolidated fiber composite material—greatly enhances mobility for the wearer. Furthermore, a region 408 of the body armor plate 400 that is configured to cover the majority of the chest of the wearer may be made of fully consolidated fiber composite material to provide greater penetration and deformation resistance when impacted by a projectile, thereby protecting vital organs, such as the heart and lungs. Being integral to the entire composite material, this fully consolidated region 408 may supplement energy absorption for impacts on areas (e.g., 404, 406, etc.) that are partially consolidated.

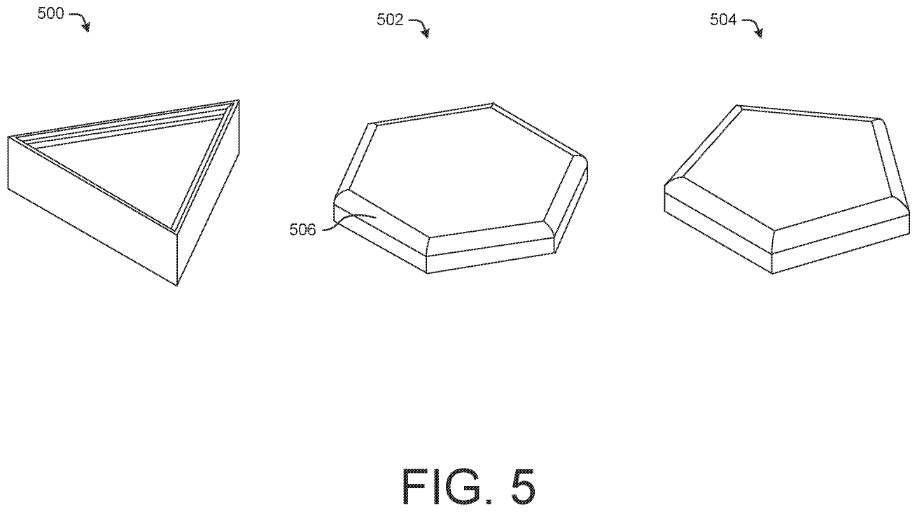

FIG. 5 illustrates a perspective view of example modular tool pieces for use in manufacturing partially consolidated composites. That is, the tooling used to manufacture partially consolidated fiber composite can include one or more individual pieces that are patterned into the desired array, instead of, or in addition to, using the tools 100A and 100B, which may represent monolithic tool plates having protruding and/or recessed features. The tooling depicted in FIG. 5 can be used with a heated platen press, such as by mounting the individual pieces or bits to a base plate having mounting features (e.g., holes, joints, slots, or brackets, etc.) and pressing the tool pieces and base plate into a precursor material. For example, a base plate of the tooling used with a heated platen press may include a patterned array (e.g., a grid) of mounting features, and the individual tool pieces shown in FIG. 5 can be mounted to the mounting features of the base plate to form a custom array of patterned protrusions for use in manufacturing a partially consolidated fiber composite, as described herein with respect to the example monolithic tools 100. Different shapes and configurations can be used to alter the flexibility and performance of the composite, similar to the monolithic tools 100 described herein. In the example of FIG. 5, a first tool piece 500 has a triangular shape, a second tool piece 502 has a hexagonal shape, and a third tool piece 504 has a pentagonal shape. It is to be appreciated, however, that these are merely example shapes that can be used for modular or swappable tool pieces. While the edges 506 of the flat surface at the distal end of the tool pieces 500/502/504 can be relatively sharp, in some implementations, those edges 506 may have a slight curvature or fillet, as shown in the example tool piece 502 of FIG. 5. This may also be the case for the protrusions 102 of the monolithic tools 100 (e.g., the flat pressing surfaces at the distal ends of the protrusions 102 may have edges and/or end in corners that are curved or filleted). A curved tool edge 506 may help mitigate shearing of the fibers of the precursor material in the vicinity of the edge 506 of the tool piece 500/502/504 from the pressure applied to the precursor material, and the curved edge may reduce the chance of damage that could otherwise compromise performance (e.g., ballistic resistance performance) of the manufactured composite material 200 at the transition between consolidated regions 202 and the unconsolidated regions 204.

Although using a heated platen press is described as an example technique for manufacturing a composite material, such as the composite material 200, that is both flexible and effective at protecting a body from ballistic threats, other methods of manufacturing such composite materials are contemplated herein. For example, an autoclave may be used to manufacture a partially consolidated fiber composite from a precursor material. An autoclave is a pressurized oven. The temperature in an autoclave can be increased and decreased at a controlled rate. The autoclave can be filled with compressed air and a vacuum mechanism may force air out of the autoclave or parts therein, which helps the precursor material conform the tooling inside of the autoclave. In the present disclosure, the tooling used inside of the autoclave can be one or more of the tools 100A and/or 100B (or the inverse tooling having one or more cavities, an example of which is represented in FIG. 2), as well as the tool pieces 500/502/504 shown in FIG. 5. For example, a tool 100 may be disposed in the autoclave and touching the precursor material when the autoclave is activated or operated, thereby forming a partially consolidated composite 200. In the case of autoclaved pre-impregnated fiber composites, the composite lamella can be laid upon the tool 100. The tool 100 can have any of the aforementioned design characteristics so the pressure in combination with the vacuum inside the autoclave will cause better consolidation on the portion(s) (e.g., the protrusion(s) 102) of the tool 100 that is/are in contact with the precursor material. The autoclave may further include one or more vacuum ports to pull negative pressure (e.g., a soft vacuum).

Another method of manufacturing a fiber composite material includes applying (e.g., impregnating) a dry fiber bed with matrix. Using this method, a patterned tool can be used to cause the matrix material to impregnate the fiber bed in one or more first regions, and to prevent the matrix material from impregnating the fiber bed in one or more second regions, leaving the fibers devoid of any matrix in the one or more second regions. Similar tooling, such as the tools 100A and 100B (or the inverse tooling having one or more cavities, which may be represented in FIG. 2), as well as the tool pieces 500/502/504 shown in FIG. 5, can be used for masking a portion(s) of a dry fiber bed during matrix infusion. In some examples, a resin transfer mold may use a tool, such as the tool 100, having regions (e.g., protrusions 102) that press, pinch, or clamp the fiber bed together and hinder the infiltration of matrix can be used to form the manufactured fiber composite material. The resin will then flow through the desired channels and consolidate in those areas. This manufactured composite may have one or more regions of fibers embedded in a matrix, and one or more second regions of fibers devoid of the matrix. The regions of fibers devoid of the matrix provide flexibility to the overall manufactured material, which can be controlled based on the tool (e.g., tool 100) pattern, as described herein.

Another method of manufacturing a fiber composite material includes additive manufacturing, such as three-dimensional (3D) printing or Automated Fiber Placement (AFP). For example, a 3D printer can print a matrix material onto a fiber bed to create a partially consolidated patterning of matrix around the fibers, like the above methods. The printer can also print fiber and matrix simultaneously where the printer omits the matrix or uses less matrix in specific regions of the printed material.

Another option is to manufacture a fully consolidated composite material that includes two or more matrix materials, where at least one is flexible in its consolidated state. For example, the first matrix material in region 202 may be a stiff material (e.g., epoxy, olefin, amide, etc.) and the second matrix material of region 204 may be a flexible material (e.g., thermoplastic polyurethanes, silicones, polyureas, butyl rubbers, etc.). In this example, regions 204, with the flexible matrix, would be flexible even in the consolidated state. In the case of more matrix materials, the matrix properties can be selected or tuned to result in a composite 200 that has tailored regions of higher stiffness and ballistics performance. This will effectively create a partially consolidated composite, as described above, but with better protection of the fibers, potentially more uniform surfaces, and better performance. A composite of this type can be manufactured using any of the above methods and tooling (and with flat tooling that does not include protrusions 102).

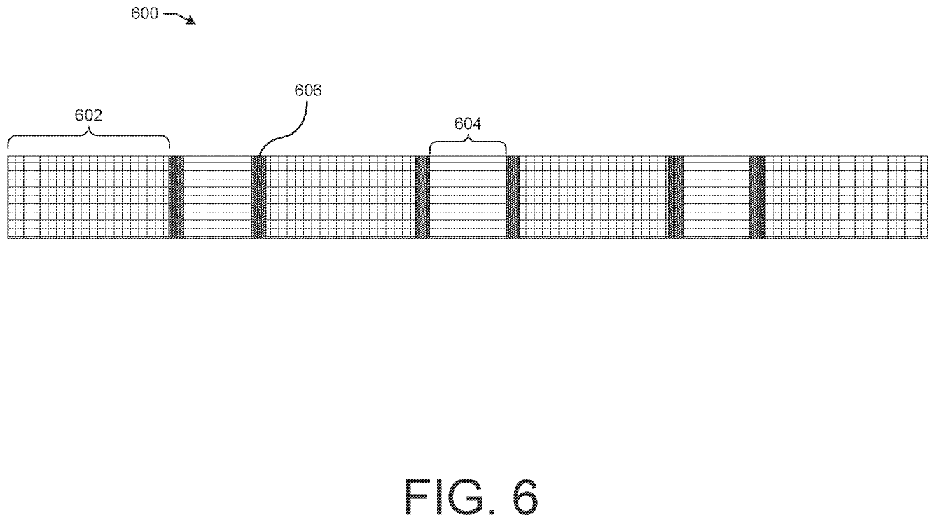

All of the above methods of manufacturing and tooling result in composite materials that have varying degrees of flexibility and mechanical performance. FIG. 6 illustrates a cross-sectional view of a nonuniform fiber composite 600. The nonuniform composite 600 includes one or more first regions 602 including first matrix and fibers embedded therein. The nonuniform composite 600 further includes one or more second regions 604 including fibers without matrix), fibers and a different (second) matrix material, or fibers and the first matrix present in a different ratio (e.g., volume fraction) of fiber to matrix than the ratio of first matrix and fibers in the one or more first regions 602. In this manner, the first region(s) 602 may differ from the second region(s) 604 in terms of at least one material property, such as flexibility or stiffness. For example, the first region(s) 602 may have one or more first material properties different from one or more second material properties of the second region(s) 604. The differing material property may include, without limitation, an elastic modulus, a hardness, a tensile strength, a compressive strength, a shear strength, or any other suitable material property that is indicative of a flexibility or a stiffness provided to the manufactured material by the material in that specific region(s). In an illustrative example, the first matrix material in region 602 may be a flexible material (e.g., thermoplastic polyurethanes, silicones, polyureas, butyl rubbers, etc.) and the second matrix material of region 604 may be a stiff material (e.g., epoxy, olefin, amide, etc.), or vice versa. Thus, the matrix properties can be selected or tuned to result in a composite 600 that has tailored regions of higher stiffness and ballistics performance.

In some implementations, the nonuniform composite 600 includes one or more third regions 606 (e.g., interlayers) interposed between the first region(s) 602 and the second region(s) 604. The third region(s) 606 may represent a diffusion or mixing zone between the two distinct regions 602 and 604 that contains the fibers embedded in a mixture of two matrix materials, the third region(s) 606 fostering better interaction between the materials in the respective, distinct regions 602 and 604. For example, load and heat are more readily transferred between the first region(s) 602 and the second region(s) 604, such that the nonuniform composite 600 is configured to efficiently propagate stress waves throughout a large area of the nonuniform composite 600. This feature is highly desirable for armor and prevents penetration of ballistic projectiles. Depending on the application and constituent materials, the design of tool and procedure may change, as would be apparent to one skilled in the art.

The present disclosure further describes a unique combination and layered distribution of engineered materials to achieve a desired level of resistance to puncture of sharp objects, bullets, and/or penetration of other ballistic projectiles. The range of threats ranges from low-velocity penetrators to high-velocity armor piercing munitions. The material system, which may represent body armor, includes a spatial distribution of principle elements assembled to: i) minimize weight and ii) provide flexibility. In one embodiment, the combination of materials can be patterned and may include, without limitation, exterior layers of ceramic and a stiff woven composite, as well as a basal layer of relatively compliant fibrous composite. The materials, in some embodiments, are combined with an adhesive system and a fabrication approach that aids in the absorption and dissipation of energy, as well as in maintaining the integrity of the system under multiple strikes/impacts. In other embodiments, an interfacial adhesive is not utilized, in favor of using an external consolidation wrap or encapsulating material. In yet another implementation, a combination of adhesive and encapsulating material is used. The specific configuration depends on the application. The overall design, choice of materials, and manner of assembly also permits adjustments, repair and replacement of elements in the event they are damaged, or alternatively to switch or swap component parts or materials based on a particular use, function, and/or application.

Based on the opportunities for tuning the material properties from the choice of the layers and their organization, the applications of these materials are very broad, as would be appreciated by one skilled in the art. The materials can be applied for protection from threats including small and medium caliber ammunitions, as well as the projectiles emitted from improvised explosive devices. Thus, the material can be utilized for military applications, including their use in protection of both personnel and vehicles, as well as for consumer safety products.

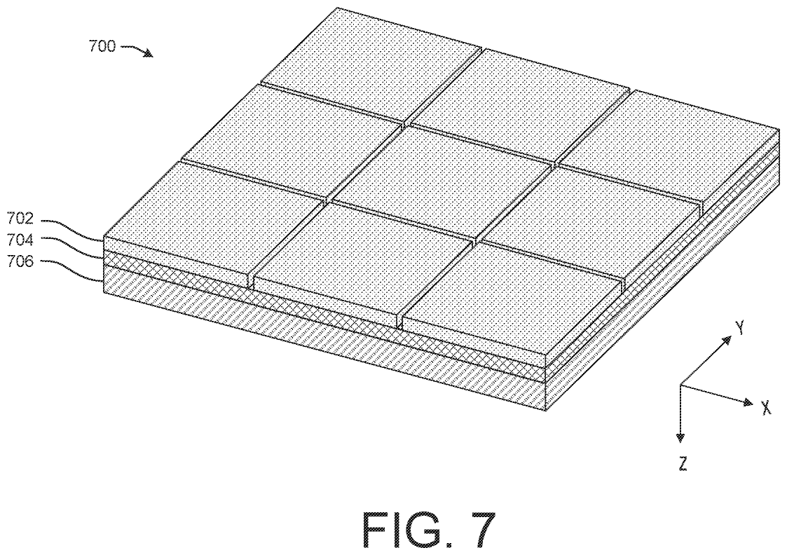

FIG. 7 illustrates a perspective view of a tri-layer composite plate 700 usable as body armor. Although three layers are illustrated in FIG. 7, it is to be appreciated that three layers are merely exemplary and that any number of layers may be included in a multi-layer composite plate. In one example, the first and outermost layer 702 may be the hardest of the layers. The outermost layer 702 can be made of a ceramic material, a hard metal, a polymer, or a composite and/or combination thereof (such as a ceramic matrix composite or ceramic reinforced composite). Thus, in at least one example, the outermost layer 702 may represent a partially consolidated fiber composite (e.g., a partially consolidated ceramic matrix composite) with square-shaped consolidated regions and the region(s) therebetween including unconsolidated ceramic matrix composite. In some examples, the outermost layer 702 can be segmented (e.g., individual, coplanar pieces of ceramic material), or the outermost layer 702 can be continuous (e.g., a partially consolidated ceramic matrix composite), depending on the application and the extent of flexibility needed. The segmentation of the material in the outermost layer 702 can be any pattern or array of geometric shapes that provides a degree of flexibility, such as quadrilateral, triangular, and hexagonal shapes. The region(s) between the segmented pieces of material in the outermost layer 702 may utilize a bonding layer to facilitate transfer of load and/or heat between the segments of material and the basal layers, or they can be tethered using fibrous materials. In some examples, the outermost layer 702 can also include a composite material with a hardness gradient and/or an elastic modulus gradient. This gradient from the outer surface inward can be a normalized value (normalized by the hardness and/or the elastic modulus at the outermost surface) that can range from 1.0 to 0.1, 1.0 being the hardest value and/or the highest elastic modulus value. More specifically, at the outer surface of the outermost layer 702, the hardness has a normalized value of 1.0. At the interface with the next principle layer 704, the hardness can be between 1.0 and 0.1 of that of the outer surface of the outermost layer 702.

The second intermediate layer 704 can include a woven fiber composite, such as a woven fiber reinforced polymer matrix composite. This intermediate layer 704 may be more compliant than the material of the outermost layer 702. An example of a material that can be used for the intermediate layer 704 is a laminate of layers of woven Kevlar® and Vectran® that are consolidated with a toughened epoxy matrix. The hardness or elastic modulus can be between 0.5 to 0.05 (normalized) of the average hardness or elastic modulus of the outermost principle layer 702. There can be multiple intermediate layers, each that possess a constant mechanical property through the thickness (e.g., in the Z direction depicted in FIG. 7) or a gradient of hardness and/or elastic modulus through the thickness, and assembled such that the outermost layer has the highest value of hardness. Furthermore, the intermediate layer(s) 704 can be any combination of different materials that are selected to achieve a gradient in hardness or stiffness from high to low from the outside inward (e.g., in the negative Z direction depicted in FIG. 7). The intermediate layer 704 can also be segmented, akin to the segmentation used for the outermost layer 702. The segmentation can be a continuation of that from the outermost layer (e.g., in phase). That is, the segments of material in the intermediate layer 704 can be aligned with the segments of material in the outermost layer 702 such that the outer segments are disposed directly over the intermediate segments (e.g., aligned in the Z direction shown in FIG. 7). In this example, the aligned segments may also be of similar size and shape. Alternatively, the segmentation may not be aligned (i.e. out of phase) between the two layers 702 and 704. That is, the segments of material in the intermediate layer 704 may be offset horizontally (e.g., offset in the X and/or Y direction(s) shown in FIG. 7) such that some, but not all, of a segment of material in the outermost layer 702 is disposed directly over an adjacent segment of material in the intermediate layer 704 (e.g., aligned in the Z direction shown in FIG. 7). The purpose of this segmentation and the relative alignment or misalignment between the layers 702 and 704 is to tune the flexibility of the entire material system to a level that is necessitated by the intended function. Further, layer 704 may represent a partially consolidated material, such as partially consolidated unidirectional Kevlar® in an epoxy matrix. Unconsolidated regions may align with the segments of material in the outermost layer 702 or may be offset horizontally, as described above, for a segmented intermediate layer 704.

The innermost layer 706, in one example, is the most ductile and compliant of the material system 700. The innermost layer 706 can include a large variety of different materials with a normalized hardness and/or elastic modulus that is between 0.95 to 0.01 of the intermediate layer 704. Consistent with the previous, this innermost layer 706 can be structured to possess a gradient of properties from the interface with the intermediate layer 704 and inward. The hardness and/or elastic modulus of this innermost layer 706 can be structured such that the properties are constant across this entire layer, or a gradient such that the portion adjacent to the intermediate layer 704 exhibits the highest value. This innermost layer 706 may serve as the membrane that conforms to the body of the structure to be protected. An example material that can be used for the innermost layer 706 is a composite laminate of very compliant polymeric fibers. The high specific strength and viscoelastic nature of the polymeric fibers allows this innermost layer 706 to excel under dynamic loading and to achieve strain rate strengthening effects. In some implementations, any of the layers 702, 704, and/or 706 may be manufactured using the techniques described herein, and, hence, may represent a fiber composite material that is both flexible and strong, such as the partially consolidated fiber composite material 200 described above with reference to FIG. 2. The material choice may vary depending on where the material is to be situated in the stack of layers in the tri-layer plate 700.

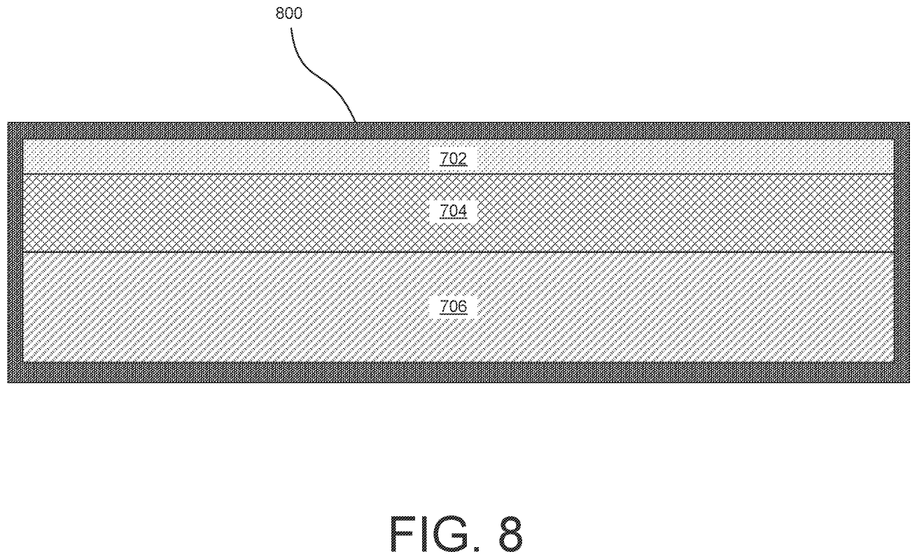

Panels including at least the three layers 702, 704, and 706 can be encapsulated with other materials to mitigate fracture or prevent expulsion of the outermost layer 702 after impact. Encapsulation has an added benefit of maintaining the integrity of the panel even after delamination of the principle layers. In addition, the encapsulation helps maintain the layers as a cohesive unit and allows the introduction and adjustment of the layered panels into a region of interest. For example, this would mitigate difficulties with inserting the panel into a plate carrier for personal protection. FIG. 8 illustrates a cross-sectional view of the tri-layer composite plate 700 of FIG. 7 contained within an encapsulating material 800.

At the interfaces of the principle layers and the individual layers within those groups, adhesive materials may be used. These materials can have an interfacial strength and toughness that supports bonding and enables the dissipation of energy through controlled delamination.

There are many possible material properties that may be utilized for all components of the proposed material system, including specific mechanical properties and thickness of the individual layers. The choice can be predicated by the desired function. Thicker outer layers are incorporated to enhance the resistance to harder projectiles. Thicker internal layers (and at least one thinner outer layer) can be incorporated for less energy transfer and lighter weight if used as personal armor.

The processes described herein are illustrated as a collection of blocks in a logical flow graph, which represent a sequence of operations. The order in which the operations are described is not intended to be construed as a limitation, and any number of the described blocks can be combined in any order and/or in parallel to implement the processes.

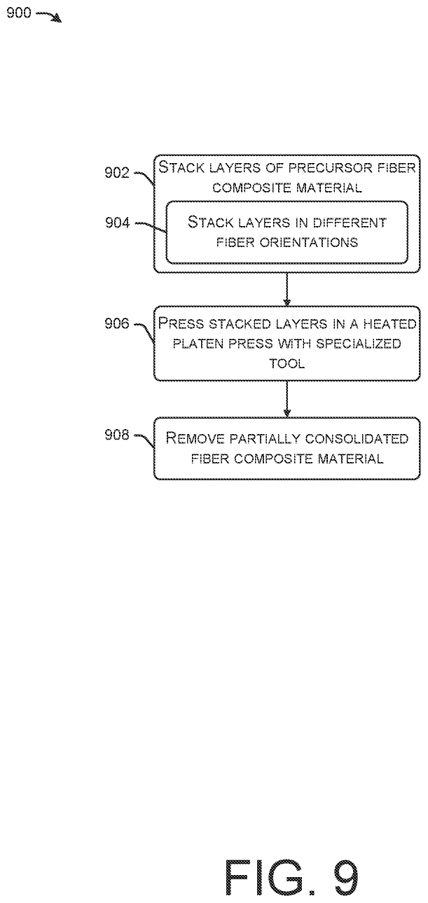

FIG. 9 illustrates an example process 900 for manufacturing a fiber composite material using a heated platen press with specialized tooling. At 902, layers of precursor material may be stacked to create stacked layers of the precursor material. At sub-block 904, the layers may be stacked in different fiber orientations relative to one another, such as by orienting first fibers of a first layer of the precursor material at an angle relative to second fibers of a second layer of the precursor material, the second layer being adjacent to the first layer. For example, first fibers (e.g., unidirectional (UD) fibers) in a first layer may be oriented at 0 degrees, second fibers (e.g., UD fibers) in a second layer adjacent to the first layer may be oriented at 45 degrees of rotation relative to the fibers of the base (first) layer, third fibers (e.g., UD fibers) in a third layer adjacent to the second layer may be oriented at 90 degrees of rotation relative to the fibers of the base (first) layer, and so on and so forth. In other examples, UD fibers may be aligned in substantially the same direction across all of the stacked layers at block 902, and/or the fibers may not be UD fibers, and/or the fibers may be woven fibers.

At 906, the stacked layers of the precursor material may be pressed in a heated platen press using a predetermined cure cycle to create a fiber composite material that is partially consolidated. For example, the precursor material may be pressed and heated to a temperature that, depending on the material, is sufficient for melting the matrix of the precursor material, such as by heating the platen press to a temperature within a predetermined temperature range. The heated platen press used to press the stacked layers at block 906 may include a tool 100, having one or more protrusions 102 or cavities such that the tool contacts some, but not all, of the precursor material during the pressing at block 906.

At 908, the fiber composite material may be removed from the heated platen press. When removed after the pressing is performed at block 906, the fiber composite material 200 may include one or more first regions 202 that contacted the tool 100 during the pressing, wherein the fiber composite material 200 is consolidated within the one or more first regions 202, and one or more second regions 204 that remained spaced apart from (e.g., did not contact) a surface of the tool 100 during the pressing, wherein the fiber composite material 200 is unconsolidated within the one or more second regions 204.

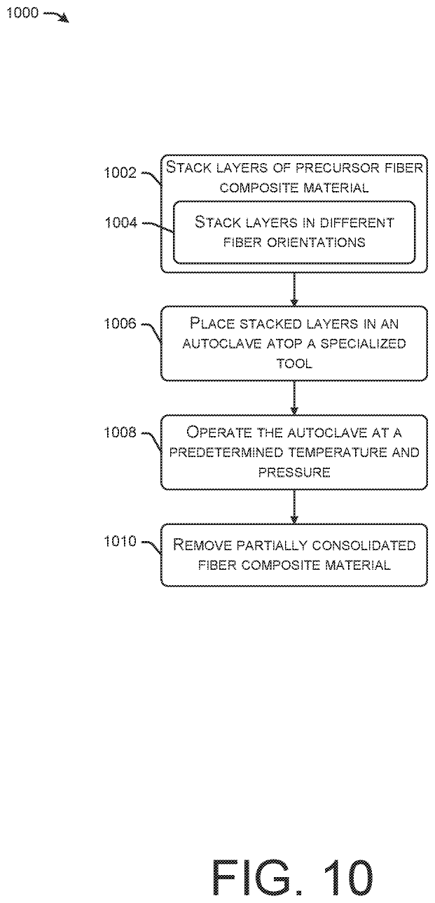

FIG. 10 illustrates an example process 1000 for manufacturing a fiber composite material using an autoclave. At 1002, layers of precursor material may be stacked to create stacked layers of the precursor material. At sub-block 1004, the layers may be stacked in different fiber orientations relative to one another, such as by orienting first fibers of a first layer of the precursor material at an angle relative to second fibers of a second layer of the precursor material, the second layer being adjacent to the first layer. For example, first fibers (e.g., unidirectional (UD) fibers) in a first layer may be oriented at 0 degrees, second fibers (e.g., UD fibers) in a second layer adjacent to the first layer may be oriented at 45 degrees of rotation relative to the base (first) layer, third fibers (e.g., UD fibers) in a third layer adjacent to the second layer may be oriented at 90 degrees of rotation relative to the base (first) layer, and so on and so forth. In other examples, UD fibers may be aligned in substantially the same direction across all of the stacked layers at block 1002, and/or the fibers may not be UD fibers, and/or the fibers may be woven fibers.

At 1006, the stacked layers of the precursor material may be placed in an autoclave, such as an autoclave used for the industrial production of composite materials. Specifically, the autoclave may include a tool 100 with the protrusions 102 or cavities facing up so that the precursor material can be laid on top of the tool 100. In some implementations, the tool 100 may be at least partially curved (e.g., concave, convex, or a combination thereof), angled, and/or contoured. Laying sheets of precursor material atop a curved, angled, and/or contoured tool allows for manufacturing a partially consolidated fiber composite that is not flat (e.g., having some amount of curvature).

At 1008, the autoclave may be operated at a predetermined cure cycle (e.g., a predetermined temperature and pressure, for a predetermined amount of time and/or cycles) to create a fiber composite material 200 that is partially consolidated. By virtue of having one or more protrusions 102 or cavities, the tool 100 in the autoclave is configured to contact some, but not all, of the precursor material during operation of the autoclave. In some implementations, the autoclave pulls negative pressure (e.g., a soft vacuum), causing the precursor material to be pulled against the tool 100 as the temperature within the autoclave is increased to a desired temperature (e.g., a temperature elevated above ambient temperature).

At 1010, the fiber composite material 200 may be removed from the autoclave. When removed after operating the autoclave at block 1008, the fiber composite material 200 may include one or more first regions 202 that contacted the tool 100 during the operation of the autoclave, wherein the fiber composite material 200 is consolidated within the one or more first regions 202, and one or more second regions 204 that remained spaced apart from (e.g., did not contact) a surface of the tool 100 during the operation of the autoclave, wherein the fiber composite material 200 is unconsolidated within the one or more second regions 204.

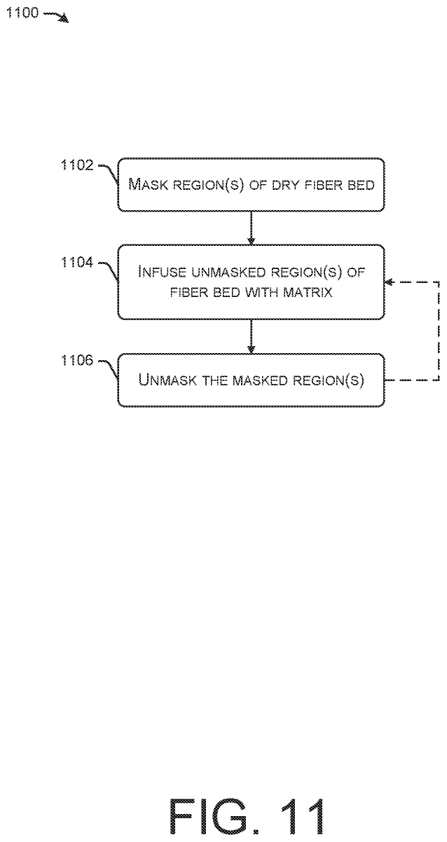

FIG. 11 illustrates an example process 1100 for manufacturing a fiber composite material by infusing matrix into a dry fiber bed. At 1102, one or more regions of a fiber bed that is devoid of matrix (e.g., a dry fiber bed) may be masked to prevent matrix material from flowing into the masked region(s). A tool, such as the tool 100A or 100B described herein, may be used for this purpose, such as by clamping a dry fiber bed between the tool 100 and another flat plate or another identical tool plate on the opposite side of the dry fiber bed.

At 1104, and after the masking at block 1102, the exposed, unmasked region(s) of the fiber bed may be infused with matrix material to impregnate a portion of the fiber bed with surrounding matrix material. In some implementations, matrix infusion at block 1104 may include supplying matrix (e.g., a resin) from a source at one side of the dry fiber bed, the source having a first pressure, and applying a second pressure at the opposite side of the fiber bed, the second pressure being lower than the first pressure, thereby causing the matrix (e.g., resin) to flow through the fibers and infuse the fibers with the desired matrix material.

At 1106, the masked regions may be unmasked, such as by unclamping the fiber bed from between the tool and an opposing plate or tool used to mask the one or more regions of the fiber bed. In some implementations, the matrix may take some amount of time to cure, and, in that scenario, the unmasking may occur at block 1106 after the matrix has been allowed enough time to cure or at least partially cure so that the matrix does not seep into the un-infused fibers upon removal of the masking tool. The resulting manufactured fiber composite 600 may include one or more first regions 602 of fibers embedded in the matrix, and one or more second regions 604 including fibers devoid of the matrix (i.e., the fibers are not surrounded by any matrix material and are otherwise exposed fibers). This manufactured fiber composite may have strength provided by the first region(s) 602 of fibers embedded in consolidated matrix, and flexibility provided by the second region(s) 604 of fibers devoid of the matrix.

As shown by the dashed arrow from block 1106 to block 1104, the process 1100 may, in some implementations, continue from block 1106 by iterating block 1104 to infuse the remainder of the exposed fibers with a different matrix material. This can create a fiber composite 600 having one or more first regions 602 of fibers embedded in a first matrix and one or more second regions 604 of the fibers embedded in a second matrix different than the first matrix. For instance, the first matrix may be a relatively rigid matrix and the second matrix may be a relatively flexible matrix, or vice versa, thereby producing a nonuniform fiber composite material 600 that is both flexible and strong. In some embodiments, a mixture of the two matrix materials may be interposed between the two distinct regions 602 and 604 in one or more third regions 606.

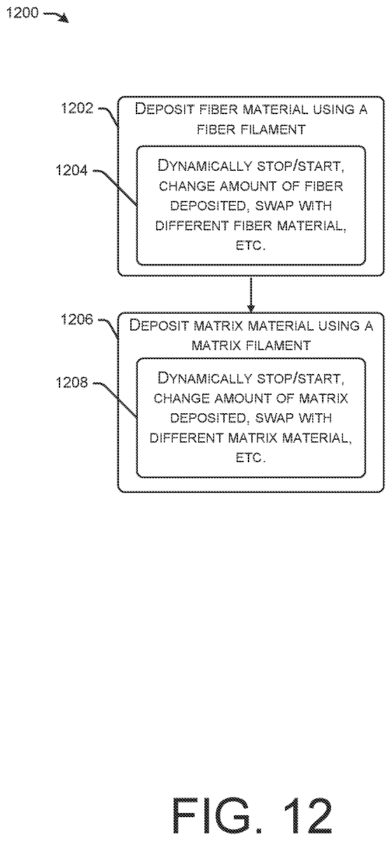

FIG. 12 illustrates an example process 1200 for manufacturing a fiber composite material using an additive manufacturing technique, such as 3D printing or AFP. At 1202, a fiber filament may deposit (e.g., print) one or more layers of a fiber material onto a platform. The fiber filament may be programmed to deposit the fiber material at particular times and in particular amounts (e.g., using a controlled flow rate of fiber material expressed from the filament head) as the filament head moves across the platform in a pre-programmed path. As shown by sub-block 1204, the fiber filament may dynamically stop and start deposition of the fiber material, and/or may dynamically change the amount of fiber material deposited (e.g., by controlling the flow rate of fiber material expressed from the filament head), and/or may dynamically swap the fiber material for a different fiber material as the filament head moves across the platform. This can result in particular fiber material being deposited at particular amounts in particular regions, as desired.

At 1206, a matrix filament may deposit (e.g., print) one or more layers of a matrix material onto the platform. The matrix filament may be programmed to deposit the matrix material at particular times and in particular amounts (e.g., using a controlled flow rate of matrix material expressed from the filament head) as the filament head moves across the platform in a pre-programmed path. As shown by sub-block 1208, the matrix filament may dynamically stop and start deposition of the matrix material, and/or may dynamically change the amount of matrix material deposited (e.g., by controlling the flow rate of matrix material expressed from the filament head), and/or may dynamically swap the matrix material for a different matrix material as the filament head moves across the platform. This can result in particular matrix material being deposited at particular amounts in particular regions, as desired. A resulting manufactured fiber composite 600 may include one or more first regions 602 that are different from one or more second regions 604 in terms of the respective material properties of those respective regions. For example, a mixed matrix composite 600 may be created using the process 1200, such as a fiber composite 600 having one or more first regions 602 of fibers embedded in a first matrix and one or more second regions 604 of fibers embedded in a second matrix different than the first matrix. Furthermore, because the amount of deposited fiber material can be controlled dynamically during deposition at sub-block 1204, a resulting manufactured fiber composite 600 may include one or more first regions 602 of fibers embedded in a matrix and one or more second regions 604 of the fibers embedded in the matrix, wherein the fibers account for a first percentage of the fiber composite material within the one or more first regions 602, and wherein the fibers account for a second percentage of the fiber composite material within the one or more second regions 604, the second percentage different than the first percentage. In other words, a composite material with variable volume fractions of fiber composite material across the plane of the material may be created. In some implementations, a single filament head or multiple filament heads is/are configured to express or extrude fiber alone, matrix alone, or both fiber and matrix material (e.g., simultaneously) so that the type, the amount, and the mixture of material deposited can be controlled along a path travelled by the filament head during deposition.

It is also to be appreciated that the process 1200 may omit blocks 1202 and 1204 if, for example, matrix material is being applied to a dry fiber bed using a 3D printer, AFP, or any other suitable additive manufacturing process. For example, a 3D printer can print the matrix material onto a fiber bed such that the matrix material seeps into the fiber bed under the force of gravity in order to create a partially consolidated and/or nonuniform material pattern.

### Example Testing

Field testing has been performed on prototype material systems with designs that conform to the descriptions in the previous section. A few examples are provided below.

Example 1: An UHMWPE composite of a 20 layers of 4-ply 0/90 Dyneema® HB26 was pressed in a heated platen press using a square-shaped segmented tool array and the recommended cure cycle from the manufacturer. This resulted in a partially consolidated array of 1.5″ square consolidated regions and 0.75″ wide unconsolidated regions. Another panel of 20 layers of 4-ply 0/90 Dyneema® HB26 was pressed in the same heated platen press and cure cycle, but with flat uniform tool plates. The fully consolidated composite was a hard and rigid plate that could not be flexed. The partially consolidated composite was flexible in all directions due to the ridges of 0.75″ wide unconsolidated regions. The areas that did get consolidated were just as stiff and hard as the fully consolidated plates. No damage was seen in the partially consolidated panels due to fillets around the perimeter (e.g., at the edges) of the square tool segments that contacted the precursor composite material. These panels were then subjected to ballistic testing. Each panel was fired upon with a 0.357 Magnum (Mag) Full Metal Jacket (FMJ) FN (145 Grain (gr); 1400 ft/s). The fully consolidated composite was struck near the center of the plate and did not penetrate. The partially consolidated composite was struck along one of the unconsolidated areas. It also did not penetrate and with back face signature comparable to that specified in the NIJ Standard-0101.06. The performance comparison illustrates that the partially consolidated version performs equally to the fully consolidated composite, but retains some flexibility that is paramount for personal protection. It is even more impressive that the bullet hit the unconsolidated portion, which should be less resistant to penetration.

Example 2: A composite of a 20 layers of 4-ply 0/90 Dyneema® HB26 was pressed in a heated platen press using a rectangular shaped segmented tool array and the recommended cure cycle from the manufacturer. It resulted in 0.75″ wide unconsolidated ridges aligned in a single direction, which resulted in a composite panel that was flexible in only one direction. A pattern of partially consolidated composite could be more beneficial for specific structural applications that require anisotropic flexibility if designed correctly. The composite was stiff in the direction needed but could be flexed in the other for easier manufacturing and design.

Example 3: A composite armor consisting of 30 layers of Dyneema® HB210 was pressed in a heated platen press using monolithic raised square tool and the recommended cure cycle. Due to the higher grade of Dyneema® and the corresponding drop in fiber diameter and ply thickness the overall result is a more flexible material than the materials of Examples 1 and 2. This material was incorporated into a ceramic composite armor including segmented silicon carbide tiles that were overlaid on the joints of the partially consolidated fiber composite introduced during the partial consolidation process. The resulting design is an armor system that can handle NIJ III projectiles while maintaining flexibility and low weight. The weight is comparable to that of a pure ultra-high molecular weight polyethylene composite armor, which is completely inflexible and significantly thicker.

Example 4: A panel, made of a three-layer design, was prepared with dimensions of 6×6 in². The top (outer) layer included a 1 cm thick stratum of 98.5% alumina. The total surface area of the 6×6 in² plate area was achieved by an arrangement of 9 separate 2×2 in² plates arranged in a 3×3 array. The middle layer was a laminate of 10 layers of a hybrid of woven Kevlar® and Vectran® polymer fibers in an epoxy matrix. The bottom layer was a laminate made of 20 layers of Dyneema® HB26. The top, middle, and bottom layers were combined with Loctite® cyanoacrylate adhesive. Field testing entailed subjecting the constructed panel to ballistic resistance testing involving 9×19 mm Full Metal Jacket (FMJ) bullets. The bullets were fired from a 9 mm weapon at the panel from a distance of 7 yards at a perpendicular angle to the outer face of the panel. The bullet impacted the center ceramic piece, which caused fracture; no deformation or damage occurred to the middle or bottom layers. The other adjacent ceramic tiles remained mostly intact with minor chipping on the edges that were shared with the one that was struck by the bullet. The remaining middle and back layers of the panel remained undamaged. This panel was subjected to a second round of firing tests, with the same ammunition and firing distance. The projectile partially penetrated the middle layer of Kevlar®/Vectran® laminate and partially delaminated the interface between the middle and bottom layers. An additional round was fired that landed 1.5 in. from the previous shot. This projectile fully penetrated the middle laminate and further delaminated the bottom laminate. However, the bullet did not penetrate the panel. A final shot was fired at the bottom layer alone. Although this fourth bullet did not penetrate the panel, it did significantly deform the Dyneema® HB26 laminate.

Example 6: This phase of evaluation involved the fabrication of three new panels that were prepared with the tri-layer design. The panels utilized the same material composition as described in Example 4, except that the adhesive was changed from cyanoacrylate to epoxy. The first panel was fired at using a 5.56×45 mm M855 steel core ammunition at a distance of 22 yards. The first round impacted the center alumina tile, which caused fracture. However, there was no penetration or damage to the back two layers from this round. A second round was fired at this panel, which hit a gap between two tiles and resulted in minor damage to the middle layer. A third and final round was fired at the remaining back two layers, and the bullet successfully penetrated through. The second panel included only the back two layers and was fired upon with 9×19 mm FMJ at 10 yards. The first round partially penetrated the woven composite layer and caused minor delamination between this layer and the underlying bottom laminate. The second bullet struck the panel in close proximity to the first and embedded in the woven composite layer; there was more delamination at the interface between the two layers. The remaining back layer was removed from the panel and fired at separately. This third layer was not penetrated.

Example 6: This phase of evaluation involved five panels that were tested with different levels of threat. The panels were modified design in that the top layer was a single 5 mm thick monolithic sheet of 99% alumina. In addition, an exterior encapsulation was used. Two panels were encapsulated in a sheet of epoxy infused, woven Kevlar® and Vectran®. Another two panels were encapsulated by a four-layer wrapping with silicone (PDMS) tape. The fifth panel was wrapped in two layers of duct tape. The two panels that were encapsulated in silicone also utilized silicone for the adhesive between the principal layers. The other three panels used epoxy as the interface adhesive. One panel each of the silicone, Kevlar®/Vectran®, and the duct tape encapsulation were tested using 7.62×39 mm rifle ammunition at 20 yards. Penetration of the bullet was prevented by all three panels. The damage manifested as a fracture of the outer layer, penetration of the middle layer, delamination of the interface between the middle and basal layer, and deformation of the base layer. The other two panels with silicone and Kevlar®/Vectran® encapsulation were tested using 5.56×45 mm M855 steel core ammunition. Six shots were fired at each of the panels from a distance of 20 yards. The first shot was placed in the center of the panel, the following four were placed in the four corners of the panels, and the final sixth shot was directed as close to the first shot as possible. For each of the two panels, only the final projectile penetrated the panels.

### Example Clauses

1. A method of manufacturing a fiber composite material, the method including: stacking layers of a precursor fiber composite material to create stacked layers of the precursor fiber composite material; pressing the stacked layers of the precursor fiber composite material in a heated platen press using a predetermined cure cycle, the heated platen press including a tool having one or more protrusions or cavities such that the tool contacts a portion of a surface of the precursor fiber composite material during the pressing to create a partially consolidated fiber composite material; and removing the partially consolidated fiber composite material from the heated platen press, the fiber composite material including: one or more first regions that contacted the tool during the pressing, wherein the partially consolidated fiber composite material is consolidated within the one or more first regions; and one or more second regions that remained spaced apart from the tool during the pressing, wherein the partially consolidated fiber composite material is unconsolidated within the one or more second regions.
2. The method of clause 1, wherein the precursor fiber composite material includes unidirectional fibers embedded in a matrix.
3. The method of clause 2, wherein the stacking includes orienting first fibers of a first layer of the precursor fiber composite material at an angle relative to second fibers of a second layer of the precursor fiber composite material, the second layer being disposed on the first layer.
4. The method of any one of clauses 1 to 3, wherein: the precursor fiber composite material includes fibers embedded in a matrix; the fibers include at least one of a metal, a ceramic, or a polymer; and the matrix includes at least one of a metal, a ceramic, or a polymer.
5. The method of any one of clauses 1 to 4, wherein the partially consolidated fiber composite material includes ultra-high-molecular-weight polyethylene (UHMWPE) fibers.
6. The method of any one of clauses 1 to 5, wherein the one or more protrusions or cavities of the tool include an array of spaced protrusions or cavities, an individual protrusion or cavity having a geometric shape.
7. The method of any one of clauses 1 to 6, wherein the tool includes a base plate and modular tool pieces mounted on the base plate in an array, the modular tool pieces protruding from the base plate, a pressing surface of each modular tool piece having a geometric shape.
8. A method of manufacturing a fiber composite material, the method including: stacking layers of a precursor fiber composite material to create stacked layers of the precursor fiber composite material; placing the stacked layers of the precursor fiber composite material in an autoclave and on a tool having one or more protrusions or cavities such that the tool contacts a portion of a surface of the precursor fiber composite material; operating the autoclave using a predetermined cure cycle to create a partially consolidated fiber composite material; and removing the partially consolidated fiber composite material from the autoclave, the fiber composite material including: one or more first regions that contacted the tool during the operating, wherein the partially consolidated fiber composite material is consolidated within the one or more first regions; and one or more second regions that remained spaced apart from the tool during the operating, wherein the partially consolidated fiber composite material is unconsolidated within the one or more second regions.
9. The method of clause 8, wherein the precursor fiber composite material includes unidirectional fibers embedded in a matrix.
10. The method of clause 9, wherein the stacking includes orienting first fibers of a first layer of the precursor fiber composite material at an angle relative to second fibers of a second layer of the precursor fiber composite material, the second layer being disposed on the first layer.
11. The method of any one of clauses 8 to 10, wherein: the precursor fiber composite material includes fibers embedded in a matrix; the fibers include at least one of a metal, a ceramic, or a polymer; and the matrix include at least one of a metal, a ceramic, or a polymer.
12. The method of any one of clauses 8 to 11, wherein the partially consolidated fiber composite material includes ultra-high-molecular-weight polyethylene (UHMWPE) fibers.
13. The method of any one of clauses 8 to 12, wherein the one or more protrusions or cavities of the tool include an array of spaced protrusions or cavities, an individual protrusion or cavity having a geometric shape.
14. A fiber composite material including: an array of spaced first regions where the fiber composite material is consolidated, an individual first region in the array including unidirectional fibers embedded in a matrix; and one or more second regions where the fiber composite material is unconsolidated, the one or more second regions including a composite laminate, each layer of the composite laminate including the unidirectional fibers embedded in the matrix.
15. The fiber composite material of clause 14, wherein the individual first region is a polygon.
16. The fiber composite material of clause 14 or 15, wherein first fibers of a first layer of the composite laminate are oriented at an angle relative to second fibers of a second layer of the composite laminate, the second layer being adjacent to the first layer.
17. The fiber composite material of any one of clauses 14 to 16, wherein the fiber composite material includes at least one of: ultra-high-molecular-weight polyethylene (UHMWPE) fibers; or a ceramic matrix composite.
18. The fiber composite material of any one of clauses 14 to 17, wherein the array includes: a first subset of the spaced first regions arranged in a first pattern; a second subset of the spaced first regions arranged in a second pattern, the second pattern different than the first pattern.
19. The fiber composite material of any one of clauses 14 to 17, wherein at least one of: the spaced first regions are uniformly-spaced; or the spaced first regions have a common geometric shape.
20. The fiber composite material of any one of clauses 14 to 19, wherein the fiber composite material is at least one of a body armor plate; or a layer of a multi-layer composite plate usable as body armor.
21. A method of manufacturing a fiber composite material, the method including: masking one or more first regions of a fiber bed that is devoid of a matrix, one or more second regions of the fiber bed being exposed after the masking; infusing the one or more second regions of the fiber bed with the matrix; and unmasking the one or more first regions of the fiber bed.
22. The method of clause 21, the matrix being a first matrix, the method further including in response to the unmasking, infusing the one or more first regions of the fiber bed with a second matrix.
23. The method of clause 21 or 22, wherein the masking includes clamping the fiber bed between a first tool plate and at least one of flat plate or a second tool plate.
24. The method of any one of clauses 21 to 23, wherein the infusing of the one or more second regions of the fiber bed with the matrix includes supplying the matrix from a source at a first side of the fiber bed, the source having a first pressure, and applying a second pressure at a second side of the fiber bed opposite the first side, the second pressure being lower than the first pressure.
25. The method of any one of clauses 21 to 23, wherein: the fiber bed includes fibers made of at least one of a metal, a ceramic, or a polymer; and the matrix includes at least one of a metal, a ceramic, or a polymer.
26. The method of any one of clauses 21 to 23, wherein the fiber bed includes ultra-high-molecular-weight polyethylene (UHMWPE) fibers.
27. A method of manufacturing a fiber composite material, the method including: depositing, using a fiber filament, one or more layers of a fiber material onto a platform; and depositing, using a matrix filament, one or more layers of a matrix material onto the platform to create the fiber composite material including: one or more first regions and one or more second regions, wherein the one or more second regions have one or more second material properties different from one or more first material properties of the one or more first regions.
28. The method of clause 27, wherein the depositing the one or more layers of the fiber material includes at least one of: dynamically stopping and starting deposition of the fiber material as a filament head of the fiber filament moves across the platform; dynamically changing an amount of fiber material deposited as the filament head of the fiber filament moves across the platform; or dynamically swapping the fiber material for a different fiber material as the filament head of the fiber filament moves across the platform.
29. The method of clause 27 or 28, wherein the depositing the one or more layers of the matrix material includes at least one of: dynamically stopping and starting deposition of the matrix material as a filament head of the matrix filament moves across the platform; dynamically changing an amount of matrix material deposited as the filament head of the matrix filament moves across the platform; or dynamically swapping the matrix material for a different matrix material as the filament head of the matrix filament moves across the platform.
30. The method of any one of clauses 27 to 29, wherein the one or more first regions of the fiber composite material include fibers embedded in a matrix; and the one or more second regions of the fiber composite material include the fibers devoid of the matrix.
31. The method of any one of clauses 27 to 29, wherein the one or more first regions of the fiber composite material include fibers embedded in a first matrix; and the one or more second regions of the fiber composite material include the fibers embedded in a second matrix different than the first matrix.
32. The method of any one of clauses 27 to 29, wherein the one or more first regions of the fiber composite material include fibers embedded in a matrix, wherein the one or more first regions include a first percentage of fibers in the fiber composite material; and the one or more second regions of the fiber composite material include the fibers embedded in the matrix, wherein the one or more second regions include a second percentage of fibers in the fiber composite material, the second percentage being different than the first percentage.
33. A fiber composite material including: one or more first regions of fibers embedded in a matrix; and one or more second regions of the fibers being devoid of the matrix.
34. A fiber composite material including: one or more first regions of fibers embedded in a first matrix; and one or more second regions of the fibers embedded in a second matrix that is different than the first matrix.
35. The fiber composite material of clause 34, further including one or more third regions of the fibers embedded in a mixture of the first matrix and the second matrix, the one or more third regions being interposed between the one or more first regions and the one or more second regions.
36. A fiber composite material including: one or more first regions of fibers embedded in a matrix, wherein the fibers account for a first percentage of the fiber composite material within the one or more first regions; and one or more second regions of the fibers embedded in the matrix, wherein the fibers account for a second percentage of the fiber composite material within the one or more second regions, the second percentage being different than the first percentage.
37. A tool for manufacturing a fiber composite material, the tool including: one or more protrusions or cavities configured to contact a portion of a surface of a precursor fiber composite material during the manufacturing of the fiber composite material.
38. The tool of clause 37, wherein the tool is included in a heated platen press and is used to press stacked layers of the precursor fiber composite material using a predetermined cure cycle.
39. The tool of clause 37, wherein the tool included in an autoclave and is used as a support plate on which stacked layers of the precursor fiber composite material are laid.
40. The tool of any one of clauses 37 to 39, wherein the one or more protrusions or cavities include an array of protrusions or cavities, an individual protrusion or cavity having a geometric shape.
41. A multi-layer composite plate including: an outermost layer made of at least one of a ceramic, a metal, or a polymer; and an innermost layer made of a fiber composite material including: one or more first regions and one or more second regions, wherein the one or more second regions have one or more second material properties different from one or more first material properties of the one or more first regions.
42. The multi-layer composite plate of clause 41, wherein the innermost layer includes a partially consolidated fiber composite material having the one or more first regions where the fiber composite material is consolidated and one or more second regions where the fiber composite material is unconsolidated.
43. The multi-layer composite plate of clause 41, wherein: the one or more first regions of the fiber composite material include fibers embedded in a matrix; and the one or more second regions of the fiber composite material include the fibers devoid of the matrix.
44. The multi-layer composite plate of clause 41, wherein: the one or more first regions of the fiber composite material include fibers embedded in a first matrix; and the one or more second regions of the fiber composite material include the fibers embedded in a second matrix different than the first matrix.
45. The multi-layer composite plate of clause 41, wherein: the one or more first regions of the fiber composite material include fibers embedded in a matrix, wherein the fibers account for a first percentage of the fiber composite material within the one or more first regions; and the one or more second regions of the fiber composite material include the fibers embedded in the matrix, wherein the fibers account for a second percentage of the fiber composite material within the one or more second regions, the second percentage different than the first percentage.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing implementations of the disclosure in diverse forms thereof.

As will be understood by one of ordinary skill in the art, each implementation disclosed herein can comprise, consist essentially of or consist of its particular stated element, step, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the implementation to the specified elements, steps, ingredients or components and to those that do not materially affect the implementation. As used herein, the term “based on” is equivalent to “based at least partly on,” unless otherwise specified.

Unless otherwise indicated, all numbers expressing quantities, properties, conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing implementations (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate implementations of the disclosure and does not pose a limitation on the scope of the disclosure. No language in the specification should be construed as indicating any non-claimed element essential to the practice of implementations of the disclosure.

Groupings of alternative elements or implementations disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain implementations are described herein, including the best mode known to the inventors for carrying out implementations of the disclosure. Of course, variations on these described implementations will become apparent to those of ordinary skill in the art upon reading the foregoing description. The inventors expect skilled artisans to employ such variations as appropriate, and the inventors intend for implementations to be practiced otherwise than specifically described herein. Accordingly, the scope of this disclosure includes all modifications and equivalents of the subject matter recited in the claims appended hereto as permitted by applicable law. Moreover, any combination of the above-described elements in all possible variations thereof is encompassed by implementations of the disclosure unless otherwise indicated herein or otherwise clearly contradicted by context.

1-13. (canceled)

14. A fiber composite material comprising:
an array of spaced first regions where the fiber composite material is consolidated, an individual first region in the array comprising unidirectional fibers embedded in a matrix; and
one or more second regions where the fiber composite material is unconsolidated, the one or more second regions comprising a composite laminate, each layer of the composite laminate comprising the unidirectional fibers embedded in the matrix.

15. The fiber composite material of claim 14, wherein the individual first region is a polygon.

16. The fiber composite material of claim 14, wherein first fibers of a first layer of the composite laminate are oriented at an angle relative to second fibers of a second layer of the composite laminate, the second layer being adjacent to the first layer.

17. The fiber composite material of claim 14, wherein the fiber composite material comprises at least one of:
ultra-high-molecular-weight polyethylene (UHMWPE) fibers; or
a ceramic matrix composite.

18. The fiber composite material of claim 14, wherein the array includes:
a first subset of the spaced first regions arranged in a first pattern; and
a second subset of the spaced first regions arranged in a second pattern, the second pattern different than the first pattern.

19. The fiber composite material of claim 14, wherein at least one of:
the spaced first regions are uniformly-spaced; or
the spaced first regions have a common geometric shape.

20. The fiber composite material of claim 14, wherein the fiber composite material is at least one of:
a body armor plate; or
a layer of a multi-layer composite plate usable as body armor.

21-33. (canceled)

34. A fiber composite material comprising:
one or more first regions of fibers embedded in a first matrix; and
one or more second regions of at least one of:
the fibers being devoid of the first matrix; or
the fibers embedded in a second matrix that is different than the first matrix.

35. The fiber composite material of claim 34, further comprising one or more third regions of the fibers embedded in a mixture of the first matrix and the second matrix, the one or more third regions being interposed between the one or more first regions and the one or more second regions.

36-40. (canceled)

41. A multi-layer composite plate comprising:
an outermost layer made of at least one of a ceramic, a metal, or a polymer; and
an innermost layer made of a fiber composite material comprising:
one or more first regions; and
one or more second regions, wherein the one or more second regions have one or more second material properties different from one or more first material properties of the one or more first regions.

42. The multi-layer composite plate of claim 41, wherein the innermost layer comprises a partially consolidated fiber composite material having the one or more first regions where the fiber composite material is consolidated and one or more second regions where the fiber composite material is unconsolidated.

43. The multi-layer composite plate of claim 41, wherein:
the one or more first regions of the fiber composite material comprise fibers embedded in a matrix; and
the one or more second regions of the fiber composite material comprise the fibers devoid of the matrix.

44. The multi-layer composite plate of claim 41, wherein:
the one or more first regions of the fiber composite material comprise fibers embedded in a first matrix; and
the one or more second regions of the fiber composite material comprise the fibers embedded in a second matrix different than the first matrix.

45. The multi-layer composite plate of claim 41, wherein:
the one or more first regions of the fiber composite material comprise fibers embedded in a matrix, wherein the fibers account for a first percentage of the fiber composite material within the one or more first regions; and
the one or more second regions of the fiber composite material comprise the fibers embedded in the matrix, wherein the fibers account for a second percentage of the fiber composite material within the one or more second regions, the second percentage different than the first percentage.

46. The multi-layer composite plate of claim 41, wherein:
an individual first region of the one or more first regions comprises unidirectional fibers embedded in a matrix; and
the one or more second regions comprise a composite laminate, each layer of the composite laminate comprising the unidirectional fibers embedded in the matrix.

47. The multi-layer composite plate of claim 46, wherein first fibers of a first layer of the composite laminate are oriented at an angle relative to second fibers of a second layer of the composite laminate, the second layer being adjacent to the first layer.

48. The multi-layer composite plate of claim 41, wherein an individual first region of the one or more first regions is a polygon.

49. The multi-layer composite plate of claim 41, wherein the fiber composite material comprises at least one of:
ultra-high-molecular-weight polyethylene (UHMWPE) fibers; or
a ceramic matrix composite.

50. The multi-layer composite plate of claim 41, wherein at least one of:
the one or more first regions are uniformly-spaced; or
the one or more first regions have a common geometric shape.

51. The multi-layer composite plate of claim 41, wherein the multi-layer composite plate is body armor.
